(19) United States
(12) Patent Application Publication
(10) Pub. No.: US 2004/0107133 A1
(43) Pub. Date: Jun. 3, 2004

(54) Capacity planning method and system

(75) Inventors: Bridget Mary Pantaleo, Scotch Plains, NJ (US); Summer Ann Fischer, North Haledon, NJ (US); Faye Abad Franzone, New York, NY (US); Gerald L. Gregorio, Staten Island, NY (US); Edward Steven Piscina, Staten Island, NY (US); Pankaj Sharma, Edison, NJ (US); Veeraraghavan Sampath, TamilNadu (IN)

Correspondence Address: McDERMOTT, WILL & EMERY, 600 13th Street, N.W., Washington, DC, 20005-3096, US

(73) Assignee: PERSHING INVESTMENTS, LLC.

(21) Appl. No.: 10/725,205

(22) Filed: Dec. 2, 2003

Related U.S. Application Data
(60) Provisional application No. 60/430,054, filed on Dec. 2, 2002.
(60) Provisional application No. 60/445,850, filed on Feb. 10, 2003.

(51) Int. Cl. G06F 17/60

(52) U.S. Cl. 705/11

(57) ABSTRACT

A capacity planning method and system determines whether an organization has sufficient staff to perform tasks. The method and system identify each of a plurality of tasks to be performed by the organization, and identify subtasks associated with each of the plurality of tasks. Production rate information related to the amount of time or the number of staff needed to perform each of the identified subtasks is then determined. Based on the identified subtasks and the production rate information, a work volume is calculated. Staff availability is determined based on staff information related to the number of employees, identities and positions of employees, exempt status of employees, staff outage, the amount of work time that cannot be used to perform the subtasks, the amount of business days, and/or the amount of defined work hours per day. A capacity report is then generated based on the work volume and the staff availability.

### RELATED APPLICATION

This application claims the benefit of priority from U.S. Provisional Patent Application Serial No. 60/430,054, titled “Capacity Planning System and Method,” filed Dec. 2, 2002; and from U.S. Provisional Patent Application Serial No. 60/445,850, titled “System, Method, Network and Software Tool for Capacity Planning,” filed Feb. 10, 2003. Disclosures of the above patent applications are incorporated herein by reference in their entireties.

### FIELD OF DISCLOSURE

This disclosure generally relates to a method and system for capacity analysis and forecasting, and more specifically, to a capacity planning method and system that identify subtasks associated with each of a plurality of tasks to be performed, and dynamically determine staff capacity based on staff availability, work schedule, and the identified subtasks.

### BACKGROUND OF THE DISCLOSURE

In an organization, such as a bank, clearing house, clearing center, or an insurance company, where numerous complex tasks are performed by its employees, it is important to know whether the capacity of the organization is sufficient to handle the number of incoming tasks. If not, additional resources need to be located/assigned, such as bringing in part-time or temporary workers, extending work hours, borrowing staff from other departments, etc., in order to perform the tasks as required in the appropriate timeframe.

Basic capacity management systems are used in some call centers to plan and manage personnel. Such systems typically include a basic planning capability to enable a call center to determine the number of agents necessary to service incoming calls based on historic data of incoming calls. Some systems may further include a scheduling capability to allocate agent work hours according to the historic data of incoming calls. For example, more agents are assigned to peak hours during the day.

Such a capacity management system is built based on the assumptions that the type and number of tasks to be performed and the amount of time needed to perform the tasks are statistically fixed or unchanged. For example, in a call center, the major task to be performed is answering incoming calls. The variance of the amount of time needed to service each incoming call is minimal. Using such assumptions, conventional capacity management systems may determine the number of agents needed by dividing the number of hourly incoming calls by the number of calls an agent can handle each hour.

However, such conventional capacity management systems are not suitable for organizations that perform complex tasks. Complex tasks usually involve different types of subtasks with various difficulties that need to be handled by employees. The amount of time needed to perform each subtask is usually different. In addition, employees in the organizations hold different positions and thus spend different amounts of time on functions other than handling the complex tasks. Such functions may include management, training, administration, etc. The primitive model used in conventional capacity planning systems does not have the ability to address such complexity.

Therefore, there is a need to provide a capacity planning system that can manage and plan personnel in organizations that handle complex tasks. There is another need to determine whether an organization has sufficient manpower to handle complex tasks. There is a further need to address the differences in the amount of time each employee can contribute to perform complex tasks.

### SUMMARY OF THE DISCLOSURE

A capacity planning method and system disclosed herein addresses one or more of the above-identified needs and may address other needs. The capacity planning method and system as disclosed also provide numerous advantages that will be appreciated and understood from the following descriptions. An exemplary capacity planning technique determines the amount of work involved in complex tasks to be performed by an organization, and determines whether the organization has sufficient staff to perform the tasks.

A method, for example, identifies each of a plurality of tasks to be performed by an organization, or groups within the organization, and identifies subtasks associated with each of the plurality of tasks. Production rate information related to the amount of time or the number of staff needed to perform each of the identified subtasks is then determined. Based on the identified subtasks and the production rate information, a work volume is calculated. The work volume may-be the total work hours needed to perform the tasks, the number of staff to perform the tasks, or the number of tasks to be performed, etc. The method then determines staff availability based on staff information related to the number of employees, exempt status of employees, identities and/or positions of employees, capability to perform subtasks, staff outage, the amount of work time that cannot be used to perform the subtasks, and the amount of business days. A capacity report is then generated based on the work volume and the staff availability. For example, the capacity report may include information related to staff required to finish one or more tasks based on the amount of tasks and the production rates for the identified subtasks.

In one example, the production rate information includes the amount of time needed to perform respective identified subtasks or the number of each identified subtasks that can be performed each hour. In another example, the work volume is calculated as the number of time units needed to perform the identified subtasks or the number of fulltime employees needed to perform the identified subtasks, based on standard work hours per day. The standard work hours may be configurable, and defined depending on design preference, or input by a system operator. For example, the standard work hours may be dependent on the type of organizations or the type of tasks and/or subtasks to be performed by the organization. The standard work hours may be defined as a fixed amount of time, such as seven work hours per day.

In still another example, the work volume is calculated as the amount of time needed to perform the subtasks, and the staff availability is calculated as the total amount of time that employees can perform the subtasks within a specific period of time, such as a month. The total amount of time that employees can perform the subtasks within the specific period of time is calculated by using the equation of: (the number of employees) * (the number of standard work hours per day) * (the number of business days within the specific period of time)−(the amount of time lost due to staff outage within the specific period of time). Time available to perform subtasks may also take into account loss of work time due to a number of other factors including fixed tasks, lent hours, etc.

In a further aspect, the exemplary capacity planning method calculates the staff availability based on the work volume, the number of employees, the information related to staff outage, the information related to the amount of work time that cannot be used to perform the subtasks, and the information related to the number of business days. The amount of work time that cannot be used to perform the subtasks depends on the position of the respective employee.

According to one embodiment, the capacity planning method as described further calculates extended staff availability by considering extended work hours, such as an eight or nine hour work day, and/or additional weekend or holiday work hours. The capacity report may be generated with information related to the extended staff availability, such as based on a first comparison between the work volume and the staff availability, and a second comparison between the work volume and the extended staff availability. According to another embodiment, the exemplary capacity planning method further includes the step of generating warnings based on the first comparison and the second comparison. For example, a code red may be generated if the staff is insufficient to handle the work volume even after the extended staff availability is taken into consideration.

A data processing system may be used to perform capacity planning as described herein. The data processing system may include a processor for processing data, a memory, a data storage device for storing data, and data transmission means, such as a bus, operatively coupled to the memory, the data storage device, and the processor. The data storage device bearing instructions to cause the data processing system upon execution of the instructions by the processor to access information related to a plurality of tasks, identify each of the plurality of tasks, identify subtasks associated with each of the plurality of tasks, access production rate information related to the amount of time or the number of staff needed to perform each of the identified subtasks, calculate a work volume based on the identified subtasks and the production rate information, access staff information, determine staff availability based on the staff information, and generate a capacity report based on the work volume and the staff availability. In one example, the production rate information is obtained from a database. The staff information and the information related to the plurality of tasks may be obtained from the data storage device and/or a remote data processing system connected to the data processing system via a network, such as the Internet.

A machine-readable medium bearing instructions may be provided to control a data processing system to perform capacity planning. The machine-readable medium may include optical storage media, such as CD-ROM, DVD, etc., magnetic storage media including floppy disks or tapes, and/or solid state storage devices, such as memory card, flash ROM, etc. The instructions upon execution by the data processing system causes the data processing system to access information related to a plurality of tasks, identify each of the plurality of tasks, identify subtasks associated with each of the plurality of tasks, access production rate information related to the amount of time or the number of staff needed to perform each of the identified subtasks, calculate a work volume based on the identified subtasks and the production rate information, access staff information, determine staff availability based on the staff information, and generate a capacity report based on the work volume and the staff availability. Such instructions may also be conveyed and transmitted using carrier waves.

Still other advantages of the presently disclosed methods and systems will become readily apparent from the following detailed description, simply by way of illustration of the invention and not limitation. As will be realized, the capacity planning method and system are capable of other and different embodiments, and their several details are capable of modifications in various obvious respects, all without departing from the disclosure. Accordingly, the drawing and description are to be regarded as illustrative in nature, and not as restrictive.

### BRIEF DESCRIPTIONS OF THE DRAWINGS

The accompanying drawings, which are incorporated in and constitute a part of the specification, illustrate exemplary embodiments.

FIG. 1 is a schematic block diagram depicting an exemplary architecture of an exemplary capacity planning system.

FIGS. 2a-2c shows exemplary data structures used in the subtask database and the employee database.

FIG. 3 shows a flow chart illustrating the operation of the exemplary capacity planning system.

FIGS. 4a-4c depict an example of capacity report generated by the exemplary capacity planning system.

FIG. 5 shows a schematic block diagram of a data processing system upon which an exemplary capacity planning system of this disclosure may be implemented.

### DETAILED DESCRIPTIONS OF ILLUSTRATIVE EMBODIMENTS

In the following description, for the purposes of explanation, numerous specific details are set forth in order to provide a thorough understanding of the present disclosure. It will be apparent, however, to one skilled in the art that the present method and system may be practiced without these specific details. In other instances, well-known structures and devices are shown in block diagram form in order to avoid unnecessarily obscuring the present disclosure.

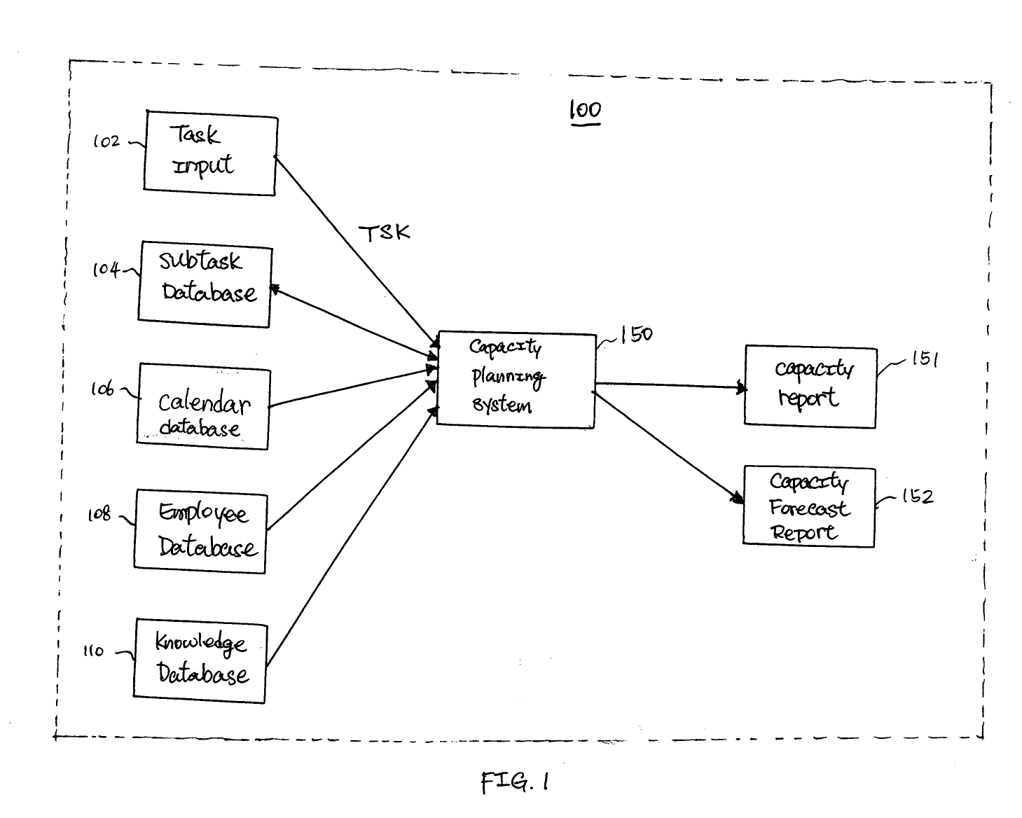

In FIG. 1, an exemplary capacity planning architecture is shown. An exemplary capacity planning system 150 is provided to generate capacity reports to show the status of total work volume and staff availability of an organization, such as a clearing house. The capacity planning system 150 has access to information from various data sources, such as task input 102, subtask database 104, calendar database 106, employee database 108, and knowledge database 110. Based on the obtained information, the capacity planning system 150 generates capacity reports 151 for the organization for a specific period of time. The capacity planning system 150 may also generate forecast reports 152 predicting future workloads and staff availability.

Box 100 represents a system of one or more data processing systems, such as computers, personal digital assistance (PDA), mobile phones, etc. The capacity planning system 150, task input 102, subtask database 104, calendar database 106, employee database 108, knowledge database 110 may be implemented as software running on that system. If the system represented by box 100 is implemented using more than one data processing systems, the data processing systems may be connected to each other with a data transmission network, such as the Internet, local area network, etc. The capacity reports 151 and forecast reports 152 may be generated on a display or displays of one or more data processing systems included in the system represented by box 100. The reports may also be sent to printers, data storage devices, other data processing systems, etc. that are coupled to the system represented by box 100.

The following embodiments use a clearing house as an illustrative example to show the operations of the exemplary capacity planning system 150. It is to be understood that the capacity planning method and system can be used in numerous types of organizations, and the application of the capacity planning method and system is not limited to the examples shown below.

A clearing house performs many complex tasks, such as domestic clearance, international clearance, government clearance, etc. In order to generate capacity reports of the clearing house for a specific period of time, the capacity planning system 150 needs to determine the overall work volume, i.e., the total amount of tasks needed to be performed by the clearing house over the specific period of time, and staff availability of the clearing house.

(1) Calculating Work Volume

The task input 102 represents a terminal for receiving input of incoming tasks to be performed by the clearing house. The input tasks may be of the same type or different types. The task input 102 may be an operator, a computer, a database, a server that takes orders or receives information from a data transmission network, and/or any combination thereof, etc.

The capacity planning system 150 identifies tasks received from the task input 102, and divides each task into a plurality of subtasks to be performed by the employees of the clearing house. The types and amount of the subtasks are determined based on statistical data and/or empirical studies of the operation of clearing house. For example, a task related to domestic clearance may include the following subtasks:

Balancing with Broker

Manual Bookkeeping Entries

Adjusting Customer Accounts

Managing Fails

Managing Breaks

Phone Calls

Report Preparation and Distribution

Suspense Balancing

Research

Reconciliation

Letters to SEC

And a task related to international clearance may include the following subtasks:

Managing Fails

Update Database

Reconciliation

Suspense Balancing

Phone Calls

Managing Breaks

Billing

Confirms

Allocations

Other possible subtasks associated with a task may include updating account information, entering data related to agreements, entering data related to margin accounts, entering data related to option accounts, entering data related to regulatory requirements, such as W9.

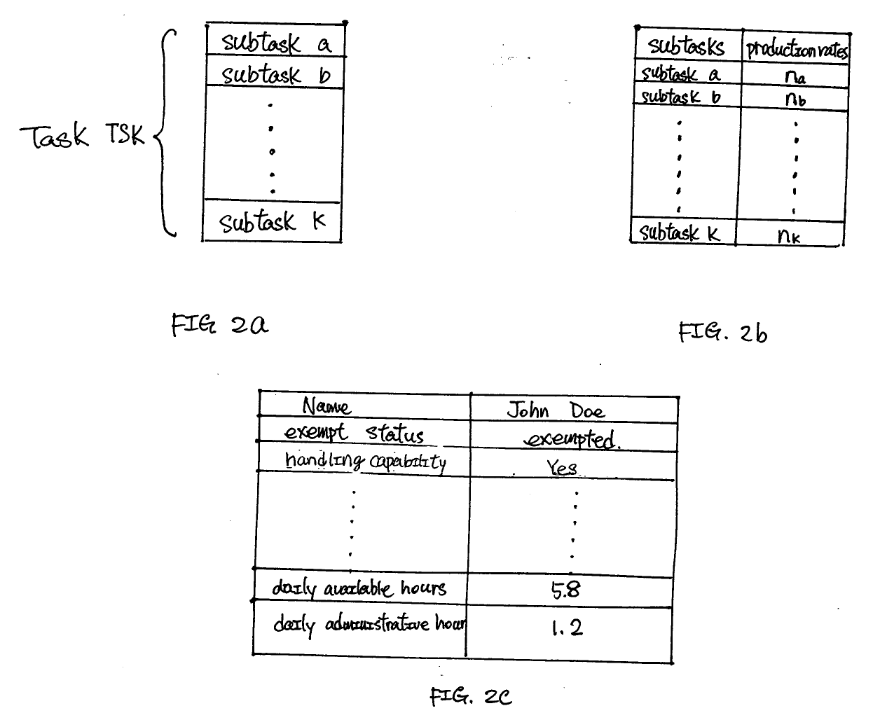

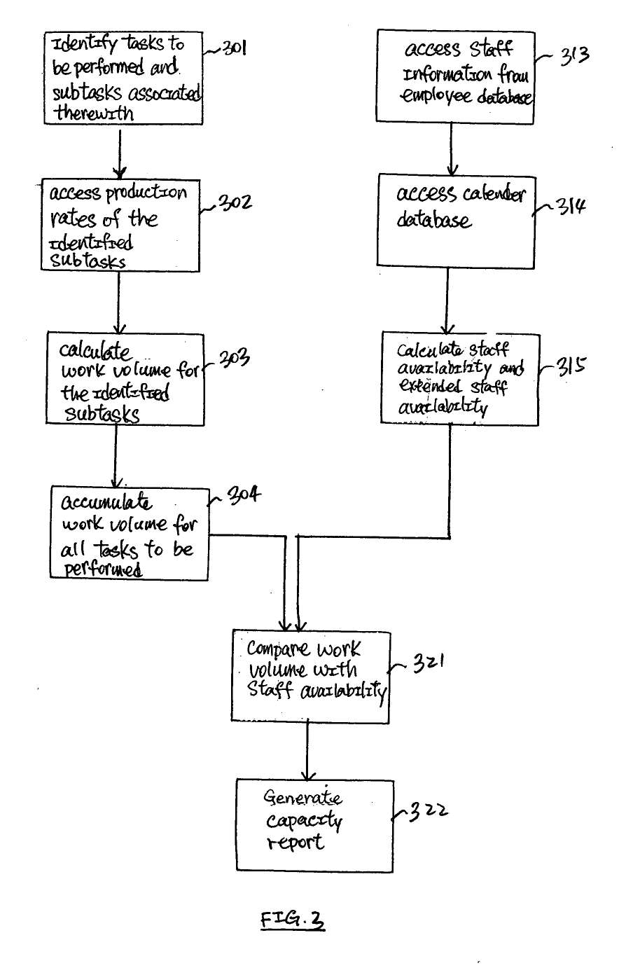

The subtask database 104 stores data related to subtasks associated with each task. The subtask database 104 may be one or a plurality of logical and/or physical databases that are local and/or remote to the capacity planning system 150. As shown in FIG. 2a, for a task TSK to be performed by the clearing house, the subtasks associated with that task TSK are subtask a, subtask b, . . . and subtask k. Different types of tasks may include subtasks having the same names, yet the functions needed to be performed may be identical or different. The subtask database 104 may use the same subtask ID to identify identical subtasks, and different subtask IDs for different subtasks.

The subtasks associated to a specific task may be logically linked to an ID representing that task, and stored in the subtask database 104. In another embodiment, the subtask database 104 may utilize a search engine to dynamically retrieve subtasks associated with a specific task each time such information is requested by the capacity planning system 150.

As shown in FIG. 2b, the subtask database 104 further includes information related to production rates corresponding to each subtask. The production rate represents a relationship between the amount of time or the number of employees needed to perform a specific subtask. For instance, the production rate may be the number of subtasks a full-time employee of the clearing house can perform each hour. In another embodiment, the production rate may be the amount of time a full-time employee needs to perform a specific subtask. Other representations or definitions of the production rate can also be used.

The production rate corresponding to each subtask may be logically linked to each subtask ID and stored in the subtask database 104. In anther embodiment, the subtask database 104 may utilize a search engine to dynamically retrieve the production rate corresponding to each subtask every time such information is requested. The production rates may be determined by an observation or empirical studies of the clearing house's operations to ascertain how much time an employee in the clearing house needs to perform a specific subtask.

After the capacity planning system 150 receives a task TSK from the task input 102, the capacity planning system 150 accesses the subtask database 104 to determine the subtasks associated with the task TSK. Based on the determined subtasks, the capacity planning system 150 accesses the subtask database 104 to obtain production rates corresponding to the subtasks associated with the task TSK. The same process will be applied to each task within the specific period of time, such as one month. The total number of each subtask is then accumulated.

After the total number of each subtask is determined, the capacity planning system 150 accesses information related to the respective production rates of the identified subtasks. The work volume is then ascertained using the following equations:

Work Volume=SUM of (the total number of each subtask/the production rate thereof);

wherein:

the work volume is the total number of employee work hours needed to perform all of the subtasks identified by the capacity planning system 150; and

the production rate represents the units of subtasks that an employee can perform in one hour.

Alternatively, if the production rate represents the time needed to perform each subtask, the work volume (total hours needed) may be calculated by multiplying the total number of each subtask by their respective production rate.

The work volume may further be adjusted to address the time spent on support functions. Support functions are routine functions that the employees need to perform, but are not related to the volume of tasks. Examples of support functions include general data entry, data updates, system maintenance, document retrieval, etc. The average hour needed for performing the support functions may be determined based on observation of the operations of the clearing house. The information may be stored in the subtask database 104 and accessible by the capacity planning system 150. The adjusted work volume is calculated using the following equation:

Work Volume=[SUM of (the total number of each subtask/the production rate thereof)]+(average daily hours for support functions * the number of days within the specific period of time)

(2) Calculating Staff Availability

In order to generate a capacity report 151 to indicate whether the clearing house has sufficient employees to handle the incoming tasks, in addition to calculating the total work volume over the specific period of time, the capacity planning system 150 needs to determine the status of staff availability based on the employees' available work hours and the total business days within that specific period of time. Information related to the number of business days of the specific period of time can be obtained from calendar database 106, which stores data related to the amount of business days and holidays of a specific period of time.

The capacity planning system 150 also accesses the employee database 108 which includes staff information related to the employees of the clearing house, including, for example, names and positions, types of subtasks they can perform, full-time/part-time status, exempt/non-exempt status, available overtime schedule, the amount of work time that can and cannot be used to handle subtasks, etc. An exemplary data structure related to an employee, John Doe, is depicted in FIG. 2c. As shown, John Doe is an exempt employee, which means John Doe is exempt from the minimum wage and overtime provisions of regulatory requirements. John Doe is capable of handling the subtasks. John Doe uses an average of 1.2 hours each day on works other than performing the subtasks and support functions, including meeting, administrative matters, training, etc. Thus, John Doe is available to work 5.8 hour on subtasks each day based on a seven-hour work day schedule.

The staff availability can be calculated as the amount of total employee work hours. The capacity planning system 150 may calculate the total employee work hours using the following equation:

Total Work Hours=total number of full-time employees * daily work hours

The total number of employees may be determined by accessing the employee database 108. The daily work hours may be set at 7 hours or any other number of hours depending on system design. In one example, the number of daily work hours is configurable, and is dependent on the tasks to be performed, the departments in the organization, and so on.

After both the work volume and staff availability are obtained, the capacity planning system 150 then generates a capacity report of the month by comparing the number of total work hours and the work volume. If the work volume is more than the total work hours, it means that the clearing house does not have sufficient resources to handle all the existing tasks based on a normal seven-hour day schedule. The human resource manager may need to take certain steps, such as requiring work over-time, bringing in part-time or temporary workers, to fill the gap.

The calculation of the total work hours may be adjusted when both full-time and other types of employees, such as part-time employees, temporary employees, interns, etc., are involved. In that case, the total work hours can be calculated using the following equation:

Total Work Hours=(total number of full-time employees * daily work hours)+(total work hours of other types of employees)

Alternatively, for simplicity of calculation, if actual work hours of other types of employees are not known, each part-time employee can be counted as 0.5 full-time employee. The weight for other types of employees can be defined by empirical studies or design preference. The total work hours can be calculated using the following equation:

Total Work Hours=(total number of full-time employees+0.5 * total number of part-time employees) * daily work hours

The capacity planning system 150 may improve the accuracy of the report to further consider work hours lost due to staff outage, such as sick days, personal vacations, paid/non-paid leave, disability, etc. Staff outage hours can be determined based on statistical data or historical of the clearing house. For instance, the records for the past three years may indicate that the total hours lost per month due to staff outage are 84 hours, which is equivalent to the work time of 0.6 full-time employee. Such information may be stored in the employee database 108. The adjusted total work hours can be calculated using the following equation:

Adjusted Total work hours=Total Work Hours−Staff Outage Time;

wherein:

Staff Outage Time=(average daily hours lost due to staff outage * the number of days within the specific period of time)

In another embodiment, the staff outage time may be calculated as the actual work time lost due to staff outage for all employees during a specific period of time.

Furthermore, the available work hours can be adjusted by considering work hours borrowed from, or lent to, employees, i.e., subtracting hours borrowed from employees and adding hours lent to employees.

Moreover, the capacity planning system 150 may improve the accuracy of the capacity report by further considering additional time that employees need to spend on managerial functions other than the tasks or subtasks, such as taking training classes, attending meetings, performing supervisory work, performing administrative work, etc. The average time spent on managerial functions can be determined based on statistical data or historical of the clearing house. The average number of hours needed to spend on the managerial functions may be stored in, and obtained from, the employee database 108. The total adjusted work hours can be calculated using the following equation:

Adjusted Total Work Hours=Total Work Hours−Managerial Function Time;

wherein:

Managerial Function Time=(average daily hours lost due to managerial functions * the number of days within the specific period of time)

Alternatively, the managerial function time may be calculated as the actual work time lost due to managerial functions for all employees during a specific period of time.

Thus, according to one embodiment of the disclosure, the capacity planning system 150 calculates the total work hours based on the adjustments as discussed above:

Adjusted Total Work Hours=(Total Work Hours−Managerial Function Time−Staff Outage Time−Managerial Function Time)

The capacity planning system 150 may calculate extended staff availability by considering extended work hours using different over-time scenarios and/or expanded staff scenarios, such as borrowing staff from other departments. The extended staff availability allows managers to evaluate whether staff availability is sufficient to handle the work volume if extended work hours are used. Forecasts for additional work hours can be calculated based on different scenarios involving different classes and/or types of employees, work schedules, amount of work hours, etc. One example may use the following scenario:

8-hour Day Non-exempt: non-exempt employees working an additional hour per day

9-hour Day Exempt: non-exempt employees working an additional hour, and exempt employees working two additional hours per day.

Weekend Hours: 5-hour work schedule on Saturdays for four weeks.

Similar to the staff availability as discussed earlier, the extended staff availability can be calculated as the number of work hours using the following equation:

Total Work Hours under Extended Staff Availability=total number of employees * (daily work hours+extended work hours under various over-time scenarios)

(3) Generating Capacity Report

After the work volume and staff availability have been determined, the capacity planning system generates a capacity report 151 by comparing the work volume and the staff availability, and optionally the extended staff availability. Various warnings may be generated based on the comparisons. For example, a code yellow may be triggered if the existing work volume needs employees to work under one of various over-time scenarios, and a code red may be generated if the staff is insufficient to handle the work volume even after the extended staff availability is taken into consideration.

In generating the capacity report 151, the capacity planning system 150 may include information related to cost analysis. For example, indices related to the cost per unit of each subtask can be calculated by dividing the total employee salaries with the number of subtasks handled during a specific period of time.

The capacity planning system 150 may also provide a capacity forecast report 152 that evaluates the capacity of the clearing house to handle incoming tasks for the future. The estimated work volume may be calculated by the knowledge database 110 based on historical work data with respect to different attributes, such as market status, seasonal factors, holidays, dividend announcements, etc. The capacity planning system 150 may then generate forecast reports using the methods as described above.

FIG. 3 depicts a flow chart illustrating the operation process of the capacity planning system 150 in generating a capacity report. In Step 301, the capacity planning system 150 identifies a task received from task input 102, and the subtasks associated with the received task. In Step 302, the capacity planning system 150 accesses information related to the production rates of the identified subtasks by accessing the subtask database 104. In Steps 303 and 304, based on the obtained information, the capacity planning system 150 calculates work volume using the methods as discussed above.

In calculating staff availability, the capacity planning system 150 accesses staff information from employee database 108 and calendar information from the calendar database (Steps 313 and 314). After such information is obtained, the capacity planning system 150 calculates staff availability and optionally extended staff availability (Step 305). In Step 321, the capacity planning system 150 compares the work volume staff availability, and generates a capacity report as discussed above (Step 322).

The capacity planning system 150 as described above may be used to dynamically track the volume of incoming tasks in real time and determine whether an organization has sufficient staff to handle the incoming tasks at any given time. The capacity planning system may also be used to generate capacity reports for an extended period of time to determine whether new employees or additional workers need to be brought in. The system also provides forecast on future workload and staff availability.

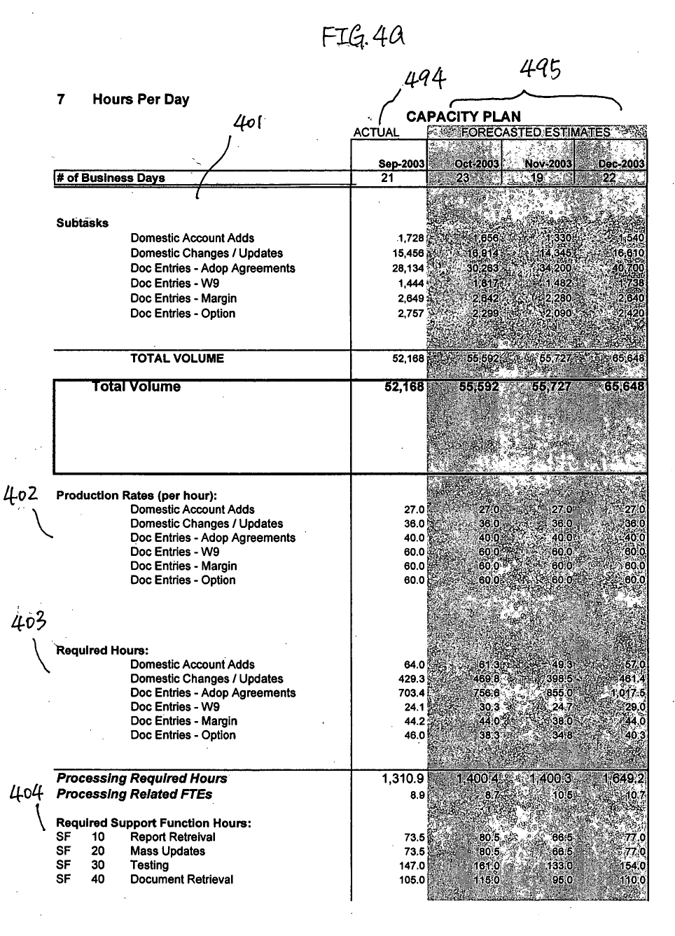

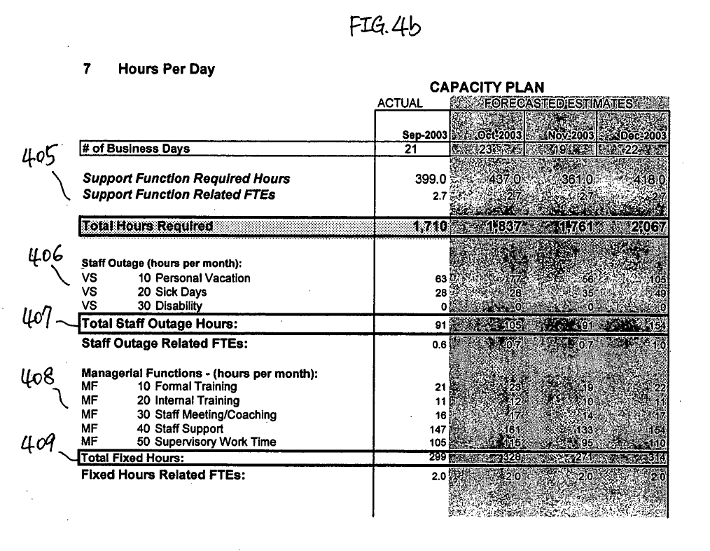

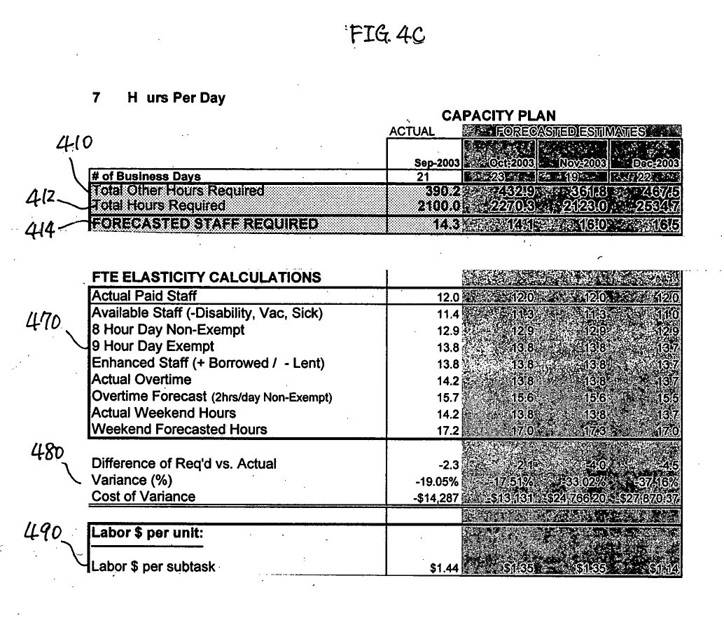

FIGS. 4a-4d shows an exemplary capacity report generated by the capacity planning system as described above, using a seven work hour day scenario. In FIG. 4a, area 494 includes data for September 2003, and area 495 contains forecast data corresponding to October, November and December 2003. Area 401 lists exemplary subtasks to be performed by an organization, including adding domestic account, document entries, etc. The numbers to the right of the area 401 show the number of subtasks to be performed in the respective month. As shown in FIG. 4a, the total number of subtasks for September 2003 is 52,168.

Area 402 lists the production rates for various subtasks listed in area 401. In this example, the production rate is defined as the number of subtasks can be performed per hour. In area 403, the required hours for performing each subtask are shown. The number is obtained by dividing the number of subtasks by their respective production rates. Thus, in September, the total amount of work hours for “domestic account adds” are 64 work hours. Area 403 also shows the total number of work hours required for performing the subtasks, i.e., work volume, as 1310.9 hours in September, which is comparable to the work hours of 8.9 full-time employees (FTEs).

Area 404 lists the required Support Function hours including report retrieval, data updates, and testing and document retrieval. In FIG. 4b, area 405 shows the total number of hours needed to perform support functions. For September, the total hours for support function are 399 hours, which is comparable to the work hours of 2.7 full-time employees (FTEs). Areas 406, 407, 408, 409 show the hours lost due to staff outage and performing managerial functions, respectively. In FIG. 4c, area 410 shows the total number of work hours needed for functions other than performing the subtasks. The number is obtained by adding the hours lost due to staff outage (area 407) and managerial functions (area 409). Area 412 includes information related to total hours needed to perform the subtasks (area 403) and support functions (area 405). In this example, the total work hours needed for September 2003 is 2150 hours (1710 hr+390 hr). Area 414 indicates that the total work hours needed for September 2003 are comparable to the work hours of 14.3 full-time employees (FTEs).

In FIG. 4c, area 470 shows data related to staff availability as well as extended staff availability under different over-time scenarios. As seen in area 470, the actual number of paid staff for September 2003 is 12, and available staff (after taking staff outage into consideration) is 11.4. Extended staff availability under 8-hour day non-exempt and 9-hour day exempt scenarios is 12.9 and 13.8, respectively. Apparently, in September, the staff availability (11.4 FTE) is not sufficient to handle the work volume (which needs 14.3 FTE).

Area 480 includes information related to variance of the staff availability, which is defined as the difference between the number of required FTE and actual paid staff, and divided by the number of actual paid staff. Area 480 also includes information related to cost of variance in staff availability, which indicates the monthly cost to fill the staff shortage. For example, if the annual salary of a full-time employee is 75,000, the cost of variance is (−2.3 * 75000/12=−$14287, for September 2003). In area 490, an index related to monthly labor cost per subtask is provided. The index is obtained by calculating the total monthly salaries of the actual paid employees, and dividing the result by the total number of subtasks.

Preferred embodiments of the hardware for the capacity planning systems utilize general purpose computers in the form of servers or host computers or in the form of personal computers (PCs). It is presumed that readers are familiar with the structure and operation of these various electronic devices. However, for completeness, it may be helpful to provide a summary discussion here of exemplary general purpose computers.

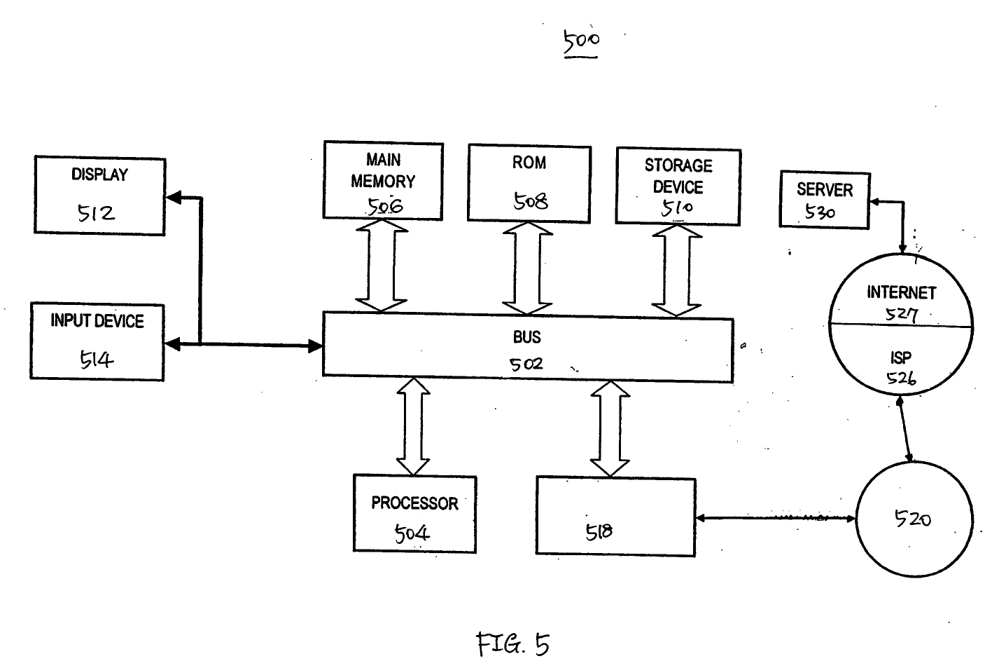

FIG. 5 shows a block diagram of an exemplary data processing system 500 upon which the capacity planning system 150 and/or the system represented by box 100 may be implemented. The data processing system 500, which may be used to implement the capacity planning system 150 and/or the system represented by box 100, includes a bus 502 or other communication mechanism for communicating information, and a data processor 504 coupled with bus 502 for processing data. The data processing system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by data processor 504. Data processing system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions. The data processing system 500 and/or any of the sensors and/or terminals may also have suitable software and/or hardware for converting data from one format to another. An example of this conversion operation is converting format of data available on the system 5 to another format, such as a format for facilitating transmission of the data.

The data processing system 500 may be coupled via bus 502 to a display 512, such as a cathode ray tube (CRT) or liquid crystal display (LCD), for displaying information to an operator. An input device 514, including alphanumeric and other keys, is coupled to bus 502 for communicating information and command selections to processor 504. Another type of user input device is cursor control (not shown), such as a mouse, a touch pad, a trackball, or cursor direction keys and the like for communicating direction information and command selections to processor 504 and for controlling cursor movement on display 512.

The data processing system 500 is controlled in response to processor 504 executing one or more sequences of one or more instructions contained in main memory 506. Such instructions may be read into main memory 506 from another machine-readable medium, such as storage device 510. Execution of the sequences of instructions contained in main memory 506 causes processor 504 to perform the process steps described herein. In alternative embodiments, hard-wired circuitry may be used in place of or in combination with software instructions to implement the disclosed capacity planning. Thus, capacity planning embodiments are not limited to any specific combination of hardware circuitry and software. Those skilled in the art will recognize that the computer system 500 may run other programs and/or host a wide range of software applications, including one or more used in performance of a company's normal operation tasks, which were analyzed by the capacity planning system.

The term “machine readable medium” as used herein refers to any medium that participates in providing instructions to processor 504 for execution or providing data to the processor 504 for processing. Such a medium may take many forms, including but not limited to, non-volatile media, volatile media, and transmission media. Non-volatile media includes, for example, optical or magnetic disks, such as storage device 510. Volatile media includes dynamic memory, such as main memory 506. Transmission media includes coaxial cables, copper wire and fiber optics, including the wires that comprise bus 502 or an external network. Transmission media can also take the form of acoustic or light waves, such as those generated during radio wave and infrared data communications, which may be carried on the links of the bus or network.

Common forms of machine readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a data processing system can read.

Various forms of machine-readable media may be involved in carrying one or more sequences of one or more instructions to processor 504 for execution. For example, the instructions may initially be carried on a magnetic disk of a remote data processing system, such as a server. The remote data processing system can load the instructions into its dynamic memory and send the instructions over a telephone line using a modem. A modem local to data processing system 500 can receive the data on the telephone line and use an infrared transmitter to convert the data to an infrared signal. An infrared detector can receive the data carried in the infrared signal and appropriate circuitry can place the data on bus 502. Of course, a variety of broad-band communication techniques/equipment may be used. Bus 502 carries the data to main memory 506, from which processor 504 retrieves and executes instructions and/or processes data. The instructions and/or data received by main memory 506 may optionally be stored on storage device 510 either before or after execution or other handling by the processor 504.

Data processing system 500 also includes a communication interface 518 coupled to bus 502. Communication interface 518 provides a two-way data communication coupling to a network link 520 that is connected to a local network. For example, communication interface 518 may be an integrated services digital network (ISDN) card or a modem to provide a data communication connection to a corresponding type of telephone line. As another example, communication interface 518 may be a wired or wireless local area network (LAN) card to provide a data communication connection to a compatible LAN. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network to data equipment operated by an Internet Service Provider (ISP) 526. ISP 526 in turn provides data communication services through the world wide packet data communication network now commonly referred to as the Internet 527. Local network and Internet 527 both use electrical, electromagnetic or optical signals that carry digital data streams. The signals through the various networks and the signals on network link 520 and through communication interface 518, which carry the digital data to and from data processing system 500, are exemplary forms of carrier waves transporting the information.

The data processing system 500 can send messages and receive data, including program code, through the network(s), network link 520 and communication interface 518: In the Internet example, a server 530 might transmit a requested code for an application program through Internet 527, ISP 526, local network and communication interface 518. The program, for example, might implement capacity planning, as outlined above. The communications capabilities also allow loading of relevant data into the system, for processing in accord with the capacity planning application.

The data processing system 500 also has various signal input/output ports for connecting to and communicating with peripheral devices, such as printers, displays, etc. The input/output ports may include USB port, PS/2 port, serial port, parallel port, IEEE-1394 port, infra red communication port, etc., and/or other proprietary ports. The data processing system 500 may communicate with other data processing systems via such signal input/output ports.

Although currently the most common type, those skilled in the art will recognize that the PC is only one example of the types of data processing systems a user may operate to communicate via the Internet. Other end-user devices include portable digital assistants (PDAs) with appropriate communication interfaces, cellular or other wireless telephone devices with web or Internet access capabilities, web-TV devices, etc.

Additional variations to the capacity planning system are available. For instance, when calculating the total amount of time lost due to managerial functions, a more precise method may be used rather than using statistical measures or historical data. As discussed earlier relative to FIG. 2c, the staff information stored in the employee database 108 includes information related to hours that a specific employee cannot be used to perform the subtasks. Such lost time varies from employee to employee due to their respective positions, administrative responsibilities and/or other duties. Thus, when accessing the staff information, the capacity planning system 150 may accumulate the unavailable hours of each employee to generate an accurate number of amount of time lost due to managerial functions, rather just an estimate obtained from historical statistics.

It is intended that all matter contained in the above description and shown in the accompanying drawings shall be interpreted as illustrative and not in a limiting sense. It is also to be understood that the following claims are intended to cover all generic and specific features herein described and all statements of the scope of the various inventive concepts which, as a matter of language, might be said to fall there-between.

What is claimed is:

1. A capacity planning method comprising the steps of:
identify each of a plurality of tasks;
identifying subtasks associated with each of the plurality of tasks;
accessing production rate information related to a relationship between the amount of time or the number of staff needed to perform each of the identified subtasks;
calculating a work volume based on the identified subtasks and the production rate information;
accessing staff information;
determining staff availability based on the staff information; and
generating a capacity report based on the work volume and the staff availability.

2. The capacity planning method of claim 1, wherein the production rate information includes the amount of time needed to perform respective identified subtasks.

3. The capacity planning method of claim 1, wherein the production rate information includes the number of each identified subtasks that can be performed per one time unit.

4. The capacity planning method of claim 3, wherein the time unit is an hour.

5. The capacity planning method of claim 1, wherein the production rate information is obtained from a database or by observation.

6. The capacity planning method of claim 1, wherein the work volume is calculated as the number of time units needed to perform the identified subtasks.

7. The capacity planning method of claim 1, wherein the work volume is calculated as the number of fulltime employees needed to perform the identified subtasks, based on standard work hours per day.

8. The capacity planning method of claim 7, wherein the standard work hours per day are configurable.

9. The capacity planning method of claim 1, wherein the staff information includes at least one of information related to the number of employees, capability of a specific employee to perform the subtasks, information related to exempt status of employees, information related to staff outage, information related to work time that cannot be used to perform the subtasks, and information related to business days within a specific period of time.

10. The capacity planning method of claim 9, wherein the information related to the number of employees includes at least one of the number of full-time employees, the number of other types of employees, the total hours worked by other types of employees expressed as a full-time employee equivalent; and
the other types of employees include at least one of part-time employees, temporary employees, interns, and borrowed staff.

11. The capacity planning method of claim 9 further comprising the step of calculating extended staff availability by considering extended work hours; and
wherein the capacity report is generated further based on the extended staff availability.

12. The capacity planning method of claim 11, wherein the extended staff availability is calculated based on a plurality of overtime scenarios or a plurality of expanded staff scenarios.

13. The capacity planning method of claim 11, wherein the capacity report is generated based on a first comparison between the work volume and the staff availability, and a second comparison between the work volume and the extended staff availability.

14. The capacity planning method of claim 13 further including the step of generating warnings based on the first comparison and the second comparison.

15. The capacity planning method of claim 9, wherein
the work volume is calculated as the amount of time needed to perform the subtasks; and
the staff availability is calculated as the total amount of time that employees can perform the subtasks within a specific period of time.

16. The capacity planning method of claim 15, wherein the total amount of time that employees can perform the subtasks within the specific period of time is calculated by using the equation of:
(the number of employees) * (the number of standard work hours per day) * (the number of business days within the specific period of time)−(the amount of time lost due to staff outage within the specific period of time)−(the amount of work time that cannot be used to perform the subtasks within the specific period of time)

17. The capacity planning method of claim 16, further comprising the step of calculating extended staff availability by considering extended work hours; and
wherein the capacity report is generated further based on the extended staff availability.

18. The capacity planning method of claim 17, wherein the extended staff availability is calculated based on a plurality of over time scenarios or on a plurality of expanded staff scenarios.

19. The capacity planning method of claim 18, wherein the capacity report includes a cost analysis.

20. The capacity planning method of claim 9, wherein the staff availability is calculated based on at least one of the number of employees, the information related to staff outage, the information related to the amount of work time that cannot be used to perform the subtasks, the information related to business days, and the amount of defined work hours per day.

21. The capacity planning method of claim 20, wherein the information related to the amount of work time that cannot be used to perform the subtasks depends on at least one of the position, the identity, the exempt status, the handling capability, and the outage status of the respective employee.

22. A data processing system for capacity planning comprising:
a processor for processing data;
a memory;
a data storage device for storing data;
bus means operatively coupled to the memory, the data storage device, and the processor;
the data storage device bearing instructions to cause the data processing system upon execution of the instructions by the processor to perform the steps of:
accessing information related to a plurality of tasks;
identify each of the plurality of tasks;
identifying subtasks associated with each of the plurality of tasks;
accessing production rate information related to the amount of time or the number of staff needed to perform each of the identified subtasks;
calculating a work volume based on the identified subtasks and the production rate information;
accessing staff information;
determining staff availability based on the staff information; and
generating a capacity report based on the work volume and the staff availability.

23. The data processing system of claim 22, wherein the production rate information includes the amount of time needed to perform respective identified subtasks.

24. The data processing system of claim 22, wherein the production rate information includes the number of each identified subtasks that can be performed per one time unit.

25. The data processing system of claim 24, wherein the time unit is an hour.

26. The data processing system of claim 22, wherein the production rate information is obtained by observation or from a database in the data storage device.

27. The data processing system of claim 22, wherein work volume is calculated as the number of time units needed to perform the identified subtasks.

28. The data processing system of claim 22, wherein the work volume is calculated as the number of fulltime employees needed to perform the identified subtasks, based on standard work hours per day.

29. The data processing system of claim 28, wherein the standard work hours per day are configurable.

30. The data processing system of claim 22, wherein the staff information includes at least one of information related to the number of employees, information related to identities and positions of employees, information related to exempt status of employees, information related to staff outage, information related to the capability of a specific employee to perform the subtasks, information related to work time that cannot be used to perform the subtasks, and information related to business days in a specific period of time.

31. The data processing system of claim 22, wherein the staff information and the information related to the plurality of tasks are obtained from at least one of the data storage device and a remote data processing system connected to the data processing system via a network.

32. The data processing system of claim 30, wherein the information related to the number of employees includes at least one of the number of full-time employees, the number of other types of employees, and the total hours worked by other types of employees expressed as a full-time employee equivalent; and
the other types of employees include at least one of part-time employees, temporary employees, interns and borrowed staff.

33. The data processing system of claim 30, wherein the data storage device further stores instructions that, when executed by the data processor, control the data processing system to perform the step of calculating extended staff availability by considering extended work hours; and
wherein the capacity report is generated further based on the extended staff availability.

34. The data processing system of claim 33, wherein the extended staff availability is calculated based on a plurality of overtime scenarios or a plurality of expanded staff scenarios.

35. The data processing system of claim 33, wherein the capacity report is generated based on a first comparison between the work volume and the staff availability, and a second comparison between the work volume and the extended staff availability.

36. The data processing system of claim 35, wherein the data storage device further stores instructions that, when executed by the data processor, control the data processing system to perform the step generating warnings based on the first comparison and the second comparison.

37. The data processing system of claim 30, wherein the work volume is calculated as the amount of time needed to perform the subtasks; and
the staff availability is calculated as the total amount of time that employees can perform the subtasks within a specific period of time.

38. The data processing system of claim 37, wherein the total amount of time that employees can perform the subtasks within the specific period of time is calculated by using the equation of:
(the number of employees) * (the number of standard work hours per day) * (the number of business days within the specific period of time)−(the amount of time lost due to staff outage within the specific period of time)−(the amount of work time that cannot be used to perform the subtasks within the specific period of time)

39. The data processing system of claim 30, wherein the staff availability is calculated based on at least one of the number of employees, the information related to staff outage, the information related to work time that cannot be used to perform the subtasks, the information related to business days, and the information related to defined work hours per day.

40. The data processing system of claim 39, wherein the information related to work time that cannot be used to perform the subtasks depends on at least one of the position, the identity, the exempt status, the handling capability, and the outage status of the respective employee.

41. A program comprising instructions, which may be embodied in a machine-readable medium, for controlling a data processing system to perform capacity planning, the instructions upon execution by the data processing system causing the data processing system to perform the steps comprising:
accessing information related to a plurality of tasks;
identify each of the plurality of tasks;
identifying subtasks associated with each of the plurality of tasks;
accessing production rate information related to the amount of time or the number of staff needed to perform each of the identified subtasks;
calculating a work volume based on the identified subtasks and the production rate information;
accessing staff information;
determining staff availability based on the staff information; and
generating a capacity report based on the work volume and the staff availability.

42. The program of claim 41, wherein the production rate information includes the amount of time needed to perform respective identified subtasks.

43. The program of claim 42, wherein the production rate information includes the number of each identified subtasks that can be performed per one time unit.

44. The program of claim 43, wherein the time unit is an hour.

45. The program of claim 41, wherein work volume is calculated as the number of time units needed to perform the identified subtasks.

46. The program of claim 41, wherein the work volume is calculated as the number of fulltime employees needed to perform the identified subtasks, based on standard work hours per day.

47. The program of claim 41, wherein the staff information includes at least one of information related to the number of employees, information related to identities and positions of employees, information related to exempt status of employees, information related to the capability of a specific employee to handle the subtasks, information related to staff outage, information related to work time that cannot be used to perform the subtasks, and information related to business days in a specific period of time.

48. The program of claim 47, wherein the information related to the number of employees includes at least one of the number of full-time employees, the number of other types of employees, and the total hours worked by other types of employees expressed as a full-time employee equivalent; and
the other types of employees include at least one of part-time employees, temporary employees, interns, and borrowed staff.

49. The program of claim 47 further including instructions that, when executed by the data processor, control the data processing system to perform the step of calculating extended staff availability by considering extended work hours; and
wherein the capacity report is generated further based on the extended staff availability.

50. The program of claim 49, wherein the extended staff availability is calculated based on a plurality of over time scenarios or a plurality of expanded staff capacity.

51. The program of claim 49, wherein the capacity report is generated based on a first comparison between the work volume and the staff availability, and a second comparison between the work volume and the extended staff availability.

52. The program of claim 51 further including instructions that, that, when executed by the data processor, control the data processing system to perform the step generating warnings based on the first comparison and the second comparison.

53. The program of claim 47, wherein
the work volume is calculated as the amount of time needed to perform the subtasks; and
the staff availability is calculated as the total amount of time that employees can perform the subtasks within a specific period of time.

54. The program of claim 53, wherein the total amount of time that employees can perform the subtasks within the specific period of time is calculated by using the equation of:
(the number of employees) * (the number of standard work hours per day) * (the number of business days within the specific period of time)−(the amount of time lost due to staff outage within the specific period of time)−(the amount of work time that cannot be used to perform the subtasks within the specific period of time)

55. The program of claim 47, wherein the staff availability is calculated based on at least one of the number of employees, the information related to staff outage, the information related to work time that cannot be used to perform the subtasks, the information related to business days, and the information related to defined work hours per day.

56. The program of claim 55, wherein the information related to work time that cannot be used to perform the subtasks depends on at least one of the position, the identity, the exempt status, the handling capability, and the outage status of the respective employee.
